(19) United States
(12) Patent Application Publication
(10) Pub. No.: US 2012/0204532 A1
(43) Pub. Date: Aug. 16, 2012

(54) FUEL SUPPLY SYSTEM WITH MULTIPLE PUMPING MEANS

(75) Inventors: Nicolas POTEL, Maisons Alfort (FR); Regis Michel Paul DELDALLE, Servon (FR)

(73) Assignee: SNECMA, Paris (FR)

(21) Appl. No.: 13/369,628

(22) Filed: Feb. 9, 2012

(30) Foreign Application Priority Data
Feb. 11, 2011 (FR) 11 51144

(51) Int. Cl. F02G 3/00

(52) U.S. Cl. 60/39.48

(57) ABSTRACT

The invention proposes a system for supplying (10) fuel to an aircraft turbomachine, which includes
a low-pressure circuit (14) in which a low-pressure pump (12) is installed, and
a high-pressure circuit (44) supplying an injection device (20) of the turbomachine and actuators (22) of components of the turbomachine, which includes several high-pressure pumps (30, 32),
characterised in that each of the said high-pressure pumps (30, 32) consists of a stage of a high-pressure pump with several stages, each stage of the said pump with several stages being associated with each of the said segments (24, 26).

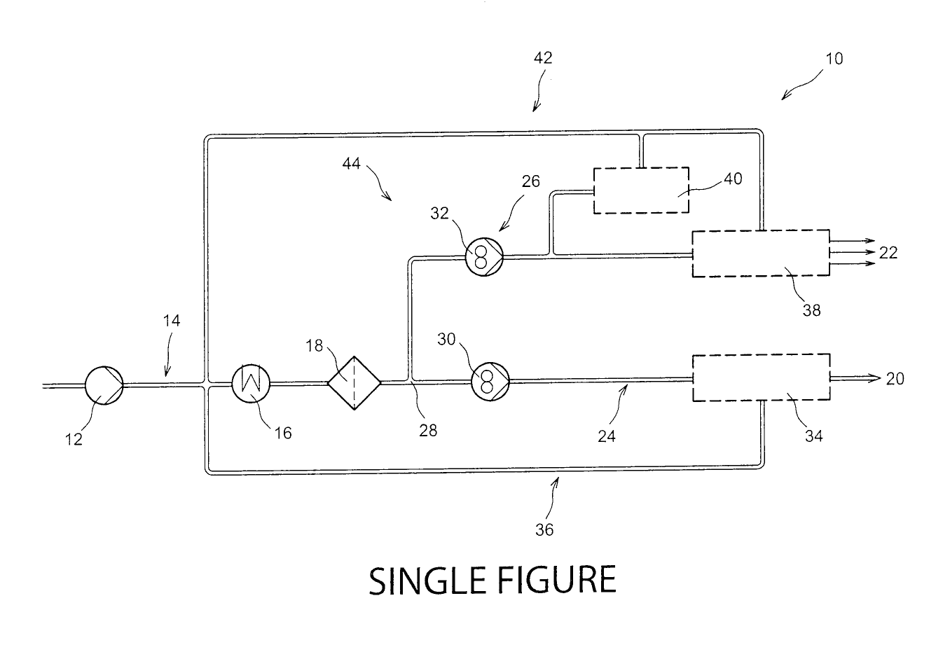

### TECHNICAL FIELD

The invention proposes a system for supplying fuel to an aircraft turbomachine including means of pumping fuel at high pressure which are suitable for the flow rates and pressures required by the components of the turbomachine which is to be supplied.

### STATE OF THE PRIOR ART

In a current turbomachine the fuel is used in the turbomachine's injection device to supply the combustion chamber; the fuel is also used to drive components of the turbomachine such as variable-geometry blade actuators of the turbomachine.

A conventional fuel supply system includes a low-pressure pump supplying a low-pressure circuit, and a high-pressure pump.

A first downstream segment of the high-pressure circuit supplies the turbomachine's injection device; a second downstream segment of the high-pressure circuit supplies actuators and jacks of the turbomachine such as variable-geometry blade actuators.

The low-pressure pump is dimensioned such that the high-pressure pump is “crammed” with fuel, i.e. such that the high-pressure pump always receives a sufficient quantity of fuel, whatever the speed and load conditions of the turbomachine.

The high-pressure pump is dimensioned to be able to supply the turbomachine's organs at a recommended flow rate and fuel pressure for each operating point of the turbomachine.

The fuel which is pumped by the high-pressure pump is distributed between the injection, the actuators and jacks of the turbomachine, and a recirculation circuit in which the fuel not used by the injection and the actuators returns upstream of the high-pressure pump.

The distribution of the fuel between these various points of the turbomachine varies according to the operation of the turbomachine, i.e. according to the flight point.

During an in-flight turbomachine restart phase, which is implemented after the turbomachine has been stopped, the turbomachine is in autorotation, i.e. the rotation of the turbomachine is only the consequence of the relative flow of the air in the compressor and turbine blades, due to the movement of the aircraft.

This speed of rotation of the turbomachine at this in-flight restart point is relatively low compared to the speed of rotation of the turbomachine's other operating points.

Due to its structure, the high-pressure pump provides a flow rate and a pressure which vary with the turbomachine's speed of rotation.

Thus, at the in-flight restart point, the high-pressure pump delivers a flow rate and pressure which are lower than the turbomachine's other operating points.

The characteristics of the high-pressure pump are determined according to this in-flight restart point, such that the pump is able to deliver the injection device with a flow rate and pressure which are sufficient to allow the turbomachine to be restarted.

I.e., the high-pressure pump is dimensioned such that the proportion of fuel which it pumps, and which supplies the injection device, is sufficient for an in-flight restart.

The other portion of the fuel pumped by the high-pressure pump, which supplies the turbomachine's actuators, is then defined according to this in-flight restart point, according to the previously defined distribution.

Consequently, concerning the turbomachine's other operating points, the high-pressure pump pumps a quantity of fuel which is greater than the quantity of fuel required for the injection device and for the actuators. The high-pressure pump is therefore oversize and it consumes excessive energy compared to the energy actually used. This results in heating of the system and increased consumption of the turbomachine.

To reduce the energy consumed by the high-pressure pump it has been proposed to use a variable-capacity pump or a two-stage pump.

The variable-capacity pump enables the flow rate at the outlet of the high-pressure pump to be varied. However, such a pump is complex to develop. Such a pump is thus subject to many disturbances caused by the actuators in the course of their operation.

A two-stage pump is designed such that one and/or the other of the two stages of the pump communicate(s) with the outlet of the pump to modify the flow rate at the outlet of the high-pressure pump.

However, when the pump is switched sudden increases of pressure and disturbances occur at the outlet of the pump. Such a pump is also difficult to develop, and also makes the fuel system complex.

The purpose of the invention is to propose a fuel supply system for which the dimensioning of the means of pressurisation of the fuel is optimised for the injection device and for the actuators' supply circuit.

### ACCOUNT OF THE INVENTION

The invention proposes a system for supplying an aircraft turbomachine with fuel which includes a low-pressure circuit in which a low-pressure pump is installed, and a high-pressure circuit for supplying a device for injecting the turbomachine and actuators of components of the turbomachine,

in which the high-pressure circuit includes several high-pressure pumps, where a first at least of the said pumps supplies the injection device, and where a second at least of the said pumps supplies the actuators,

and in which the high-pressure circuit includes at least one first segment associated with the supply device, in which a first high-pressure pump is installed, and at least one second segment in which a second high-pressure pump is installed, which supplies the actuators,

characterised in that each of the said high-pressure pumps consists of a stage of a high-pressure pump with several stages, each stage of the said pump with several stages being associated with each of the said segments.

The use of a pump associated with each fuel circuit enables the dimensions of each pump to be designed to suit the flow rate and pressure requirements of the supplied circuit, consequently reducing the pressure consumed by the set of high-pressure pumps.

The second segment preferably includes a valve to regulate the pressure of the fuel supplying the actuators.

The regulator valve is preferably designed so as to regulate the fuel pressure in the second segment at a predetermined fixed value.

The valve is preferably designed so as to regulate the fuel pressure in the second segment at a value which varies according to the turbomachine's operating conditions.

The high-pressure circuit preferably includes two segments, each of which includes an associated high-pressure pump and an associated pressure-regulation valve.

The high-pressure circuit preferably includes a bypass circuit, able to connect the second segment to the first segment selectively.

### BRIEF DESCRIPTION OF THE ILLUSTRATIONS

Other characteristics and advantages of the invention will appear on reading the detailed description below, for the understanding of which reference will be made to the appended illustrations, in which the single FIGURE is a diagrammatic representation of a system for supplying fuel for an aircraft turbomachine according to the invention.

### DETAILED ACCOUNT OF PARTICULAR EMBODIMENTS

In the single FIGURE a system 10 for supplying fuel to an aircraft turbomachine has been represented.

The supply system 10 includes a low-pressure circuit 14 which includes, in succession, a low-pressure pump 12, a heat exchanger 16 and a filter 18, and a high-pressure circuit 44 downstream from the low-pressure circuit 14.

The high-pressure circuit 44 supplies a device 20 for injecting the turbomachine, by which the fuel is injected in the combustion chamber of the turbomachine, and multiple actuators or jacks 22 which drive, for example, variable-geometry blades and other components of the turbomachine (not represented). In what follows the term “actuators” will be used to designate all the components of the turbomachine supplied by the high-pressure circuit, other than the injection device 20.

High-pressure circuit 44 includes to this end a first downstream segment 24 for supplying the injection device 20, and a second downstream segment 26 for supplying actuators 22 installed in parallel with one another.

Each of the downstream segments 24, 26 is supplied by the fuel originating from low-pressure circuit 14, i.e. by low-pressure pump 12.

A Y-shaped branch 28 enables the fuel to be distributed to the downstream segments 24, 26

According to the invention, each of the downstream segments 24, 26 includes an associated high-pressure pump 30, 32, which is dimensioned according to the pressure and flow rate to be delivered to the associated organ.

A first high-pressure pump 30 supplies the first downstream segment 24 supplying fuel injection device 20. This first high-pressure pump 30 is dimensioned so as to supply a sufficient quantity of fuel during an in-flight restart phase of the turbomachine, for which the turbomachine's speed of rotation is reduced.

The first high-pressure pump 30 is consequently dimensioned so as to supply a large quantity of fuel when the turbomachine is rotating at normal speeds, notably a slow speed on the ground, a takeoff speed or a cruising speed.

At these speeds the quantity of fuel supplying the injection device 20 is higher than that which is actually required by the injection device 20.

The supply system 10 includes to this end a “Fuel Metering Unit” (FMU) which delivers the fuel at the flow rate and pressure required for the injection device 20.

A first return circuit 36 enables the surplus fuel pumped by the first high-pressure pump 30 to return to the low-pressure circuit 14.

A second high-pressure pump 32 supplies the actuators 22 of the turbomachine.

This second pump 32 is dimensioned according to the actuators to be supplied with high-pressure fuel when the turbomachine is in operation, i.e. essentially all the turbomachine's operating points, except for an in-flight restart.

Consequently, the second pump 32 is dimensioned such that the minimum flow rate and pressure which the second pump 32 supplies correspond to a speed of rotation of the turbomachine which is higher than the turbomachine's speed of rotation during an in-flight restart phase.

The actuators supplied by the second high-pressure pump 32 must be supplied with fuel at different flow rates and at different times.

To this end, the supply system includes a distribution unit 38 which distributes the fuel at the outlet of the second pump 32 to each actuator 22.

The outlet pressure of the second pump varies according to the turbomachine's speed of rotation. It is thus generally greater than the pressure required for the operation of actuators 22.

To this end the supply system includes a valve 44 regulating the pressure of the fuel supplying second downstream segment 26.

According to a first aspect, the regulator valve 40 is defined such that the regulated pressure is constant whatever the turbomachine's operating conditions.

According to a second aspect, the regulator valve is defined such that the regulated pressure varies according to the turbomachine's operating conditions. The pressure of the fuel supplying the actuators is thus always optimised.

A second return circuit 42 enables the surplus fuel pumped by the second high-pressure pump 32, which originates from the distribution unit 38 and from the regulator valve 40, to return to low-pressure circuit 14.

According to a preferred embodiment, first pump 30 and second pump 32 are two portions, or stages, of the same pump. The two-stage pump then includes two outlets, each associated with a stage of the pump and a downstream segment 24, 26 of high-pressure circuit 44.

According to a variant embodiment (not represented) of the invention, the second downstream segment 26 includes several parallel ducts supplying different actuators 20, at different pressures and flow rates.

Each of these high-pressure ducts includes an associated second high-pressure pump 32 and an associated regulator valve.

These second high-pressure pumps and valves 40 associated with these parallel ducts are dimensioned according to actuators 22 which they supply, so as to consume the least possible energy.

Consequently, the supply system 10 includes more than two high-pressure pumps 30, 32, corresponding to the first high-pressure pump 30 of the first upstream segment associated with the injection device 20, and several second high-pressure pumps 32 associated with the actuators 20.

These various pumps 30, 32 can, according to the invention and as described above, constitute different stages of a pump with several stages, where each stage corresponds to the first downstream segment 24 or one of the circuits of second downstream segment 26.

According to another variant embodiment of the invention (not represented), the supply system 10 includes a bypass duct which enables second downstream segment 26 to be connected to the first downstream segment 24. The bypass duct includes an associated valve to permit, or deny, communication between the second downstream segment 26 and the first downstream segment 24.

Such a bypass duct enables the flow rate or pressure of fuel supplying the injection device 20 to be increased when the flow rate and/or pressure produced by the first high-pressure pump 30 is insufficient.

This is notably the case when the turbomachine is in autorotation and an in-flight restart phase is implemented.

This enables the dimensions of the first pump 32 to be reduced further and, consequently, this enables the power used by the pumps of the supply system 10 to be limited.

1. A system for supplying (10) fuel to an aircraft turbomachine, which includes
a low-pressure circuit (14) in which a low-pressure pump (12) is installed, and
a high-pressure circuit (44) supplying an injection device (20) of the turbomachine and actuators (22) of components of the turbomachine,
in which the high-pressure circuit (44) includes several high-pressure pumps (30, 32), where at least a first of the said pumps (30) supplies the injection device (20), and where at least a second of the said pumps (32) supplies the actuators (22),
and in which the high-pressure circuit (44) includes at least one first segment (24) associated with the supply device, in which a first high-pressure pump (30) is installed, and at least one second segment (26) in which a second high-pressure pump (32) is installed, which supplies the actuators (22),
characterised in that each of the said high-pressure pumps (30, 32) consists of a stage of a high-pressure pump with several stages, each stage of the said pump with several stages being associated with each of the said segments (24, 26).

2. A supply system (10) according to the previous claim, characterised in that the second segment (26) includes a valve (40) regulating the pressure of the fuel supplying the actuators (22).

3. A supply system (10) according to the previous claim, characterised in that the regulator valve (40) is designed to regulate the fuel pressure in the second segment (26) at a predetermined fixed value.

4. A supply system (10) according to claim 2, characterised in that the regulator valve (40) is designed to regulate the fuel pressure in the second segment (26) at a value which varies according to the turbomachine's operating conditions.

5. A supply system (10) according to any of the previous claims, characterised in that the high-pressure circuit (44) includes several second segments (26), each of which includes an associated high-pressure pump (32) and an associated pressure regulator valve (40).

6. A supply system (10) according to any of the previous claims, characterised in that the high-pressure circuit (44) includes a bypass circuit able to connect the second segment (26) to the first segment (24) selectively.
